(19) United States
(12) Patent Application Publication
(10) Pub. No.: US 2001/0004320 A1
(43) Pub. Date: Jun. 21, 2001

(54) Lighting assembly

(76) Inventor: John Wood, Preston (GB)

Correspondence Address: MICHAEL BEST & FRIEDRICH, LLP, 100 E WISCONSIN AVENUE, MILWAUKEE, WI, 53202, US

(21) Appl. No.: 09/738,184

(22) Filed: Dec. 15, 2000

(30) Foreign Application Priority Data
Dec. 15, 1999 (GB) 99 29573.5

(51) Int. Cl. F21V 7/00

(52) U.S. Cl. 362/297; 362/346

(57) ABSTRACT

A lighting assembly 10 comprises a reflector 12 secured to a support portion 14, which support portion 14 forms a projection of a bulb housing and electrical supply unit 16. The bulb support unit supports the bulb 18 and the electrical supply unit receives an electrical supply via a lead 19. The reflector 12 comprises a central diffuser 20, either side of which are horizontal sections 22a and 22b. From these horizontal sections the body of the reflector is bent downwards in first, second and third sections 24a/b, 26a/b and 28a/b respectively to form a symmetrical structure having an inverted bowl shaped cross-section which reflects light downwards out of the reflector.

This invention relates to a lighting assembly. Particularly, but not exclusively, a lighting assembly for horticultural lighting.

An existing lighting assembly for horticultural uses comprises a control unit which houses switch gear for the lighting assembly and also includes a socket for a light bulb. The lighting assembly also comprises a light bulb with an integral reflector. The whole assembly is suspended from a ceiling of the structure in which the lighting assembly is used. The removable lead is inserted in the assembly to supply power. The lead has a fitting which is commonly used with electric kettles.

Disadvantages arise with this type of system because the switch gear is particularly heavy and thus requires a method of suspension which is sufficiently strong to support its weight. Also, the use of a removable lead is disadvantageous because it can easily lead to a loose connection, which results in malfunctioning of the lighting assembly.

Furthermore, the particular structure of the lighting reflector used is critically important to the way in which light is reflected down to the plants to be illuminated.

Typically, a prior art lighting reflector will provide 20,000 to 30,000 lux at a chosen point 1 metre from a 600W sodium bulb.

It is an object of the present invention to provide a lighting reflector which has an increased lux value for the amount of light directed to a chosen point relative to the bulb.

It is also an object of the present invention to address the above mentioned disadvantages.

According to one aspect of the present invention a reflector for a lighting assembly comprises a plurality of angled reflecting portions which are arranged to reflect light from a bulb to a chosen location, wherein the angle between a first pair of adjacent reflecting portions is approximately equal to the angle between a second pair of adjacent reflecting portions.

The first pair of reflecting portions is preferably adjacent to the second pair of reflecting portions. The first pair of reflecting portions may have a reflection portion in common with the second pair of reflecting portions.

Preferably, the reflecting portions are strips, preferably elongate strips. The strips are preferably substantially flat between angles.

The reflector may have a generally bowl-shaped cross-section. In which case the first and second pairs may be located on one side of the bowl shape. The reflector is preferably approximately symmetrical, with first and second pairs of reflecting portions on each side of the reflector.

The reflector may comprise a central portion, preferably between the sets of reflecting portions on each side of the reflector.

The central portion may include a diffuser portion, which preferably has a “V” shaped cross-section, preferably formed by two elongate reflective strips. The diffuser portion is preferably arranged to be located above a light bulb and may, in use, reflect light incident thereon to the side. The angle of the “V” shape is preferably between 90° and 110°, most preferably approximately 98° to 102°.

The angle between the pairs of reflecting portions is preferably between 10° and 20°, more preferably between 13° and 17° and most preferably 15°.

A first reflecting portion, which may be adjacent to the central portion, may be angled at between approximately 33° and 37° to the horizontal, preferably approximately 35°.

A second reflecting portion which may be adjacent to the first reflecting portion may be angled at between approximately 48° and 52° to the horizontal, preferably approximately 50°.

A third reflecting portion which may be adjacent to the second reflecting portion may be angled at between approximately 63° to 67° to the horizontal, preferably approximately 65°.

Preferably, the reflector comprises three angled reflecting portions, preferably, three angled reflecting portions at each side of the central portion.

According to another aspect of the present invention a reflector for a lighting assembly comprises a plurality of angled reflecting portions which are arranged to reflect light from a bulb to a chosen location, wherein the angle between a first pair of adjacent reflecting portions is between 10° and 20° and the angle between a second pair of adjacent reflecting portions is between 10° and 20°.

The reflector is preferably for horticultural use.

According to another aspect of the present invention, a lighting assembly comprises a reflector and a lighting system unit, a first part of which lighting system unit is secured to the reflector and a second part of the lighting system unit is arranged in use to be spaced from the reflector; the first part of the lighting system unit comprising a bulb socket, a bulb igniter and an electrical supply input from the second part of the lighting system unit; the second part of the lighting system unit comprising control apparatus for the lighting system, ballast for the lighting system, an electrical supply to the first unit, and an electrical supply input.

The second part may be supported on the ground or on a solid structure. The first part and the reflector may be arranged to be suspended from a structure.

The reflector may be a reflector according to the previous aspect.

The electrical supply input of the first part of the lighting system unit may be hard wired into the lighting system unit.

The first part of the lighting system unit may be located at one end of the reflector.

All of the features described herein may be combined with any of the above aspects, in any combination.

A specific embodiment of the present invention will now be described, by way of example, and with reference to the accompanying drawings in which:

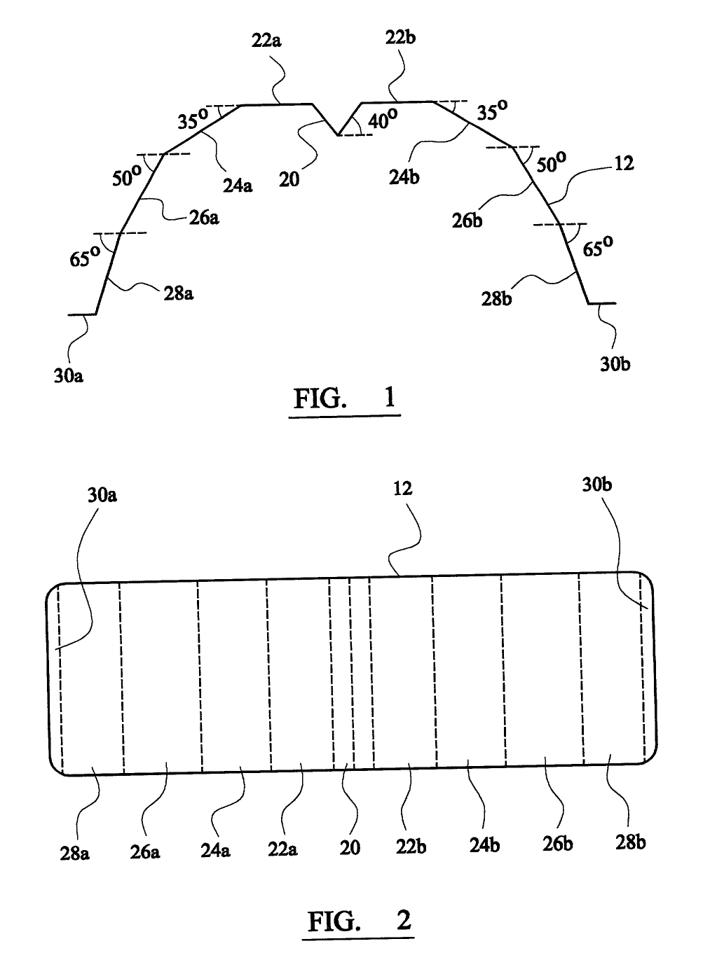

FIG. 1 is a schematic end view of a lighting reflector;

FIG. 2 is a schematic view of the lighting reflector before angles in the reflector have been formed;

FIG. 3 is a schematic cross sectional view of a lighting assembly of which the lighting reflector is a part; and

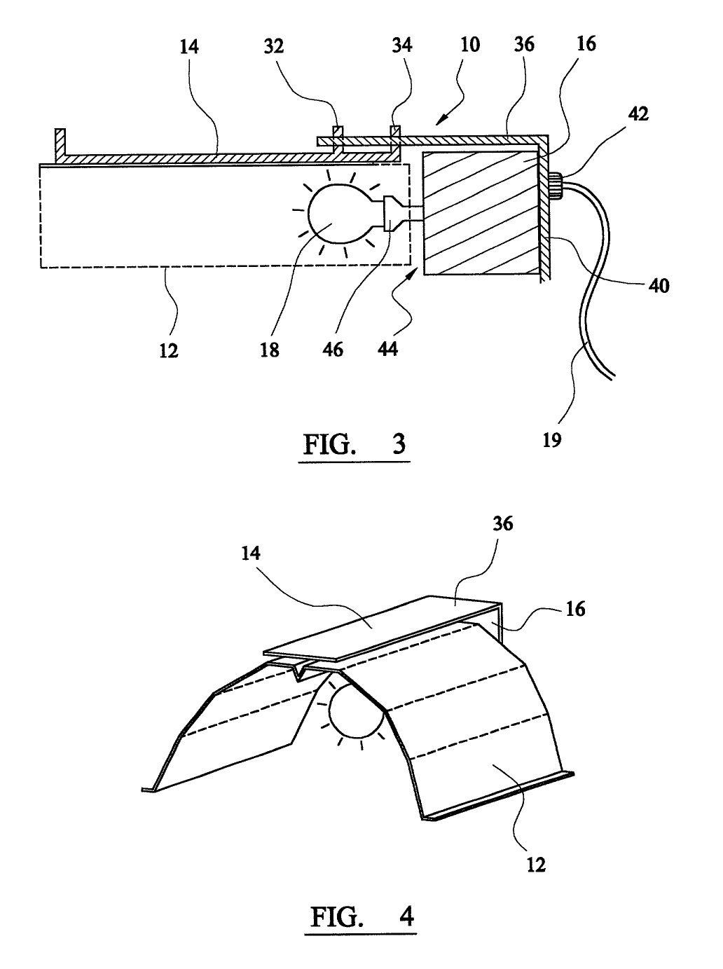

FIG. 4 is a schematic perspective view of the lighting assembly.

A lighting assembly 10 comprises a reflector 12 secured to a support portion 14, which support portion 14 forms a projection of a bulb housing and electrical supply unit 16. The bulb support unit supports a bulb 18 and the electrical supply unit receives an electrical supply via a lead 19.

In more detail, FIG. 1 shows the structure of the reflector 12, which comprises a central diffuser 20, either side of which are horizontal sections 22a and 22b. From these horizontal sections 22a and 22b the body of the reflector is bend downwards in first, second and third sections 24a/b, 26a/b and 28a/b, respectively to form a symmetrical structure having an inverted bowl shaped cross section.

The first sections 24a/b are bent downwards from their adjacent horizontal sections 22a/b at an angle of 35° to the horizontal. The second sections 26a/b are bent downwards from the first sections 24a/b at an angle of 50° to the horizontal. The third sections 28a/b are bent downwards from the second sections 26a/b at an angle of 65° to the horizontal.

The angle between adjacent first, second and third sections 24a/b, 26a/b, 28a/b respectively is 15°. Thus, the angle between adjacent first, second and third sections is constant.

The central diffuser 20 has sides which form “V” shape, each side of which is angled at 40° to the horizontal.

The arms of the “V” shape of the central diffuser 20 have a width of 15 mm. The horizontal sections 22 have a width of 50 mm. The first sections 24a/b have a width of 65 mm. The second sections 26a/b have a width of 80 mm. The third sections 28a/b have a width of 80 mm. The reflector 12 also has lip sections 30a/b at the bottom edge of the third sections 28a/b. The lip sections 30a/b are horizontally orientated and have a width of 15 mm.

The reflector 12 may be made of sheet steel, which preferably has a highly polished interior surface for good reflective properties. The reflector 12 is formed using standard fabrication techniques. Other reflective materials may be used.

The reflector 12 may have length of 305 mm, but this can, of course, be varied to suit a particular application and many lengths of reflector 12 are envisaged.

The reflector 12 comprises openings in the horizontal sections 22a/b to receive fixings of the support portion 14. The support portion comprises an extension of the bulb support and electrical supply unit 16. The support portion 14 is made of steel, and should be sufficiently rigid to support the reflector 12 with only minimal deflection. The reflector 12 is secured to the support portion 14 by means of bolts or the like. The support portion 14 is secured to the bulb support and electrical supply unit 16 by means of bolts 32. The support portion 14 may have tabs 34 to assist engagement with the bulb support and electrical supply unit 16. The bulb support and electrical supply unit 16 comprises a cover portion 36, to which the support portion 14 is secured and a housing portion 38.

The cover portion 36 forms a top side and rear side of the bulb support and electrical supply unit 16 and is formed from a single piece of sheet metal which is bent into the required 90° angle. The rear face 40 of the cover portion 36 includes an opening 42 in which is received the electrical supply lead 19.

The housing portion 38 forms the side and bottom portions of the bulb support and electrical supply unit 16. The side walls have tabs (not shown) which are bent to lay flat against the cover portion 36 so that the two can be secured together by means of suitable screws, bolts or rivets.

A front face 44 of the housing portion 38 includes an opening in which is received a ceramic bulb holder 46.

The control gear and ballast for the lighting assembly 10 is located away from the reflector and bulb support and electrical supply unit 16 on the ground, so that it is not necessary to provide strong support for supporting those parts. Also, the electrical supply lead 19 is hard wired to the bulb support and electrical supply unit 16 to provide undesired removal of the lead.

The housing portion 13 includes the bulb igniter (not shown).

In use, the bulb is illuminated and light therefrom is reflected down to the ground below. The beneficial arrangement of the reflector, with the various angles set out above, provides 40,000 lux at a chosen point 1 metre from the bulb from a 600 w sodium bulb. This figure is considerably greater than that achievable with previous lighting assemblies, because of the advantageous structure of the reflector 12.

The central diffuser 20 is important to spread light from above the bulb to the first, second and third sections which then reflect light downwards to the desired point. The relative angles of the first, second and third section advantageously reflect light to the desired point.

Small deviations from the angles set out above can be envisaged which would still provide the beneficial reflective properties set out above. However, if the angles set out above were too great, then the spread of light would be too narrow. If the angles were too shallow, then lines of shadow would appear between adjacent reflected parts of the light. The provision of a bulb support and electrical supply unit into which the electrical supply lead is hard wired has significant advantages in that inadvertent detachment of the wire is avoided. Also, by placing the switch gear and ballast in a section located on the ground, savings can be made in supporting the lighting assembly, because the support does not need the strength which would previously have been needed when the ballast and switch gear were located in the suspended unit.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A reflector for a lighting assembly having a bulb comprises a plurality of angled reflecting portions which are arranged to reflect light from a bulb to a chosen location, wherein the angle between a first pair of adjacent reflecting portions is approximately equal to the angle between a second pair of adjacent reflecting portions.

2. A reflector as claimed in claim 1, in which the first pair of reflecting portions is adjacent to the second pair of reflecting portions.

3. A reflector as claimed in claim 1, in which the reflecting portions are elongate strips.

4. A reflector as claimed in claim 3, in which the strips are preferably substantially flat between angles.

5. A reflector as claimed in claim 1, which has a generally bowl-shaped cross-section.

6. A reflector as claimed in claim 1, which is approximately symmetrical, with first and second pairs of reflecting portions on each side of the reflector.

7. A reflector as claimed in claim 1, which includes a central portion.

8. A reflector as claimed in claim 7, in which the central portion includes a diffuser portion, which has a “V” shaped cross-section.

9. A reflector as claimed in claim 8, in which the diffuser portion is arranged to be located above a light bulb and, in use, to reflect light incident thereon to the side.

10. A reflector as claimed in any claim 1, in which the angle between the pairs of reflecting portions is preferably between 10° and 20°.

11. A reflector for a lighting assembly comprises a plurality of angled reflecting portions, which are arranged to reflect light from a bulb to a chosen location, wherein the angle between a first pair of adjacent reflecting portions is between about 10° and 20° and the angle between a second pair of adjacent reflecting portions is between about 10° and 20°.

12. A reflector as claimed in claim 11, which is for horticultural use.

13. A lighting assembly comprises a reflector and a lighting system unit, a first part of which lighting system unit is secured to the reflector and a second part of the lighting system unit is arranged, in use, to be spaced from the reflector; the first part of the lighting system unit comprising a bulb socket, a bulb igniter and an electrical supply input from the second part of the lighting system unit; the second part of the lighting system unit comprising control apparatus for the lighting system, ballast for the lighting system, an electrical supply to the first unit, and an electrical supply input.

14. A lighting assembly as claimed in claim 13, in which the second part is supported on the ground or on a solid structure.

15. A lighting assembly as claimed in claim 13, in which the first part and the reflector are arranged to be suspended from a structure.

16. A light assembly as claimed in claim 13, in which the reflector is a reflector according to claim 1.

17. A lighting assembly as claimed in claim 13, in which the electrical supply input of the first part of the lighting system unit is hard wired into the lighting system unit.

18. A lighting assembly as claimed in claim 13, in which the first part of the lighting system unit is located at one end of the reflector.
